(19) United States
(12) Patent Application Publication
(10) Pub. No.: US 2015/0339749 A1
(43) Pub. Date: Nov. 26, 2015

(54) CUSTOMER-SPECIFIC SMART INNOVATION DISCOVERY SERVICE

(71) Applicants: Uwe Kuersten, Karlsruhe (DE); Stefanie Matz, Sandhausen (DE); Dirk Kempf, Walldorf (DE); Haifeng Qi, Nanjing (CN)

(72) Inventors: Uwe Kuersten, Karlsruhe (DE); Stefanie Matz, Sandhausen (DE); Dirk Kempf, Walldorf (DE); Haifeng Qi, Nanjing (CN)

(21) Appl. No.: 14/284,084

(22) Filed: May 21, 2014

(51) Int. Cl. G06Q 30/06

(52) U.S. Cl. CPC G06Q 30/0623; G06Q 30/0641

(57) ABSTRACT

The present disclosure describes methods, systems, and computer program products for innovation discovery. One computer-implemented method includes receiving a request from a customer for usage data, the request received at a request interface for a service marketplace, upon a determination that usage data exists for the customer, initiating a request for usage data, routing the request for usage data though an external and internal process integration server system interface to a business information system, extracting usage data for the customer from the business information system, and return usage data to the requesting customer.

### BACKGROUND

Business software suite customers are often unaware of innovations (e.g., functionality and/or enhancements) that are available, why the available innovations should be implemented (e.g., business value, technical reasons, etc.), and how the available innovations should be implemented (e.g., implications for existing custom code, end-user training, licenses, etc.). This lack of transparency and information results in low-volume and slow adoption of available innovations, increases overall customer cost, affects customer satisfaction, reduces the value of customer investment in a business software suite, and reduces upsell potential for the business software suite provider.

### SUMMARY

The present disclosure relates to computer-implemented methods, computer-readable media, and computer systems for innovation discovery. One computer-implemented method includes receiving a request from a customer for usage data, the request received at a request interface for a service marketplace, upon a determination that usage data exists for the customer, initiating a request for usage data, routing the request for usage data though an external and internal process integration server system interface to a business information system, extracting usage data for the customer from the business information system, and return usage data to the requesting customer.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the customer has S-user authority.

A second aspect, combinable with any of the previous aspects, wherein the determination that usage data exists for the customer can be performed for usage data within a specific time period.

A third aspect, combinable with any of the previous aspects, further comprising upon a determination that usage data does not exist for the customer, informing the customer of the availability of non-usage data.

A fourth aspect, combinable with any of the previous aspects, further comprising determining whether the routed request is a first request for usage data for the customer.

A fifth aspect, combinable with any of the previous aspects, further comprising initiating a periodic background job on the business information system to gather usage data for the customer.

A sixth aspect, combinable with any of the previous aspects, wherein the gathered usage data for the customer is periodically pushed to the service market place.

A seventh aspect, combinable with any of the previous aspects, further comprising: converting the usage data pushed to the service market place and persisting the converted usage data.

An eighth aspect, combinable with any of the previous aspects, further comprising returning a status update of the usage data push to the business information system.

The subject matter described in this specification can be implemented in particular implementations so as to realize one or more of the following advantages. First, customers receive a personalized customer-facing dashboard-type tool using a smart innovation discovery service to enable business and information technology representatives to make well-educated and solid decisions about implementing innovations into their system landscape. Second, the tool/service will provide an end-to-end experience for the entire process of innovation discovery to a final decision, including internal collaboration scenarios and mobile device applications. Third, mitigation of technical risks of implementation activities (e.g., transparency on implications) is ensured. Fourth, customers receive transparency of experiences and ratings by other customers. Fifth, overall customer satisfaction is increased with their investment in a business software suite. Sixth, adoption of innovations for business software suites will be faster and higher. Seventh, sales and pre-sales representatives for business software suites will assist in preparation for customer meetings to ensure customers and vendors are fully informed. Eighth, the service will help to increase business software suite vendor revenue from a base of customers using installed business software suites. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system (EDCS) for innovation discovery according to an implementation.

FIG. 2A is a block diagram illustrating a portion of a lower-level EDCS for innovation discovery according to an implementation.

FIG. 2B is a block diagram illustrating the remaining portion of a lower-level EDCS for innovation discovery according to an implementation.

FIG. 3 is a block diagram illustrating an integration scenario overview of a usage data initiative according to an implementation.

FIG. 4 is a block diagram illustrating the primary landscapes of the innovation discovery service for the usage data initiative according to an implementation.

FIG. 5 is a flow chart illustrating integration of customer usage data into a service marketplace according to an implementation.

FIG. 6 is a block diagram illustrating an integration scenario overview of pushing usage data from a business integration system according to an implementation.

FIG. 7 is a block diagram illustrating the primary landscapes of the innovation discovery service for pushing usage data from a business integration system according to an implementation.

FIG. 8 is a flow chart illustrating customer usage data being pushed from a business integration system to the service marketplace according to an implementation.

FIG. 9 is an example screenshot of an S-user home page user interface according to an implementation.

FIG. 10 is an example screenshot of a dashboard user interface configuration page according to an implementation.

FIG. 11 is an example screenshot of an alternative example dashboard user interface and dashboard configuration according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

This disclosure generally describes computer-implemented methods, computer-program products, and systems for innovation discovery. Although the following description is focused on business software and, particularly, business software suites, the described computer-implemented methods, computer-program products, and systems are also applicable to any type of software or product with updateable functionality and/or enhancements. The focus on business software suites is not meant to limit the applicability of the subject matter for other uses consistent with this disclosure.

Business software suite customers are often unaware of innovations (e.g., functionality and/or enhancements) that are available, why the available innovations should be implemented (e.g., business value, technical reasons, etc.), and how the available innovations should be implemented (e.g., implications for existing custom code, end-user training, licenses, etc.). This lack of transparency and information results in low-volume and slow adoption of available innovations, increases overall customer cost, affects customer satisfaction, reduces the value of customer investment in a business software suite, and reduces upsell potential for the business software suite provider.

The detailed description describes an end-to-end “innovation service application” method, computer program product, and system to provide business software suite innovation recommendations specific to individual customers. The recommendations turn the adoption of innovations into tangible value for a business plus providing related technical implications, linked and enriched with customer system usage-based data. The innovation service application is characterized by: A customer-facing self-service tool (e.g., a personalized “dashboard” application) available through a service “marketplace,” search functionality using a semantic service to enable free-text search for new functionality, leveraging various business suite provider data sources including business solution reference (BSR), innovation highlight (Innovation), product feature database (PFDB) using content ramp-up-knowledge transfer (RKT) material (e.g., customer specific material created for the customer to help understanding of innovation availability, how the new innovations will work, and how innovations customers are implemented in their system landscape), content already available for shipment (e.g., enhancement packages), and integrating customer usage data and system data with information from a customer's landscape. The end-to-end experience can include internal collaboration scenarios and may be accessible using a dedicated mobile application. Customers can also rate and enter experience information for other customer use in making a decision whether to implement one or more innovations—e.g., this helps customers ensure a mitigation of technical risks of implementation activities (e.g., transparency on implications).

For example, innovation information supplied to the customer can include, among other things: 1) Ready-to-Use—innovations that can be applied in the customer's system landscape immediately; 2) High Impact—innovations that will make a big impact on the customer (e.g., technical, financial, performance, etc.); 3) Activation Status—which innovations are already available to the customer but are not activated; and 4) Return to Standard—innovations that are available to the customer that can be used to replace customer-custom system changes (e.g., customer-changed/developed/copied functionality or competing products) with standard supplied functionality (to save customer development and maintenance costs if they switch to standard functionality).

In typical implementations, the innovation information can be presented in a service “marketplace.” For example, a customer can log into the service marketplace using a client computing device and be presented with a user-configurable dashboard-type user interface that will present the innovation information and allow the customer to, for example, select, reject, obtain additional information, etc. with respect to innovations.

Typically, the service marketplace is only available to users with a particular access authorization (e.g., S-users) permitting the users to view, access, and apply innovations to the customer system landscape. In some implementations, the S-users also have various permission levels, such as innovation Read and/or Apply access. In some implementations, the customer can grant S-user access using the service marketplace.

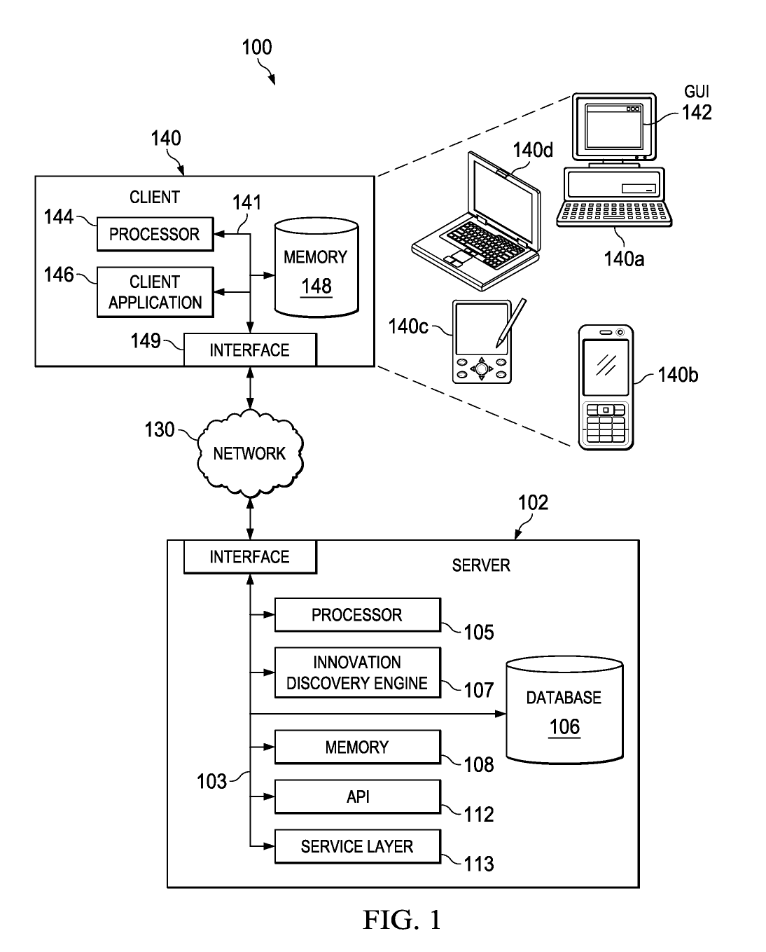

FIG. 1 is a block diagram illustrating an example distributed computing system (EDCS) 100 for innovation discovery according to an implementation. The illustrated EDCS 100 includes or is communicably coupled with a server 102 and a client 140 (an example of a computing device as mentioned above) that communicate across a network 130. In some implementations, one or more components of the EDCS 100 may be configured to operate within a cloud-computing-based environment.

At a high level, the server 102 is an electronic computing device operable to receive, transmit, process, store, or manage data and information associated with the EDCS 100. In general, the server 102 is a server providing at least functionality for innovation discovery, including innovation discovery using an innovation discovery service. According to some implementations, the server 102 may also include or be communicably coupled with an e-mail server, a web server, a caching server, a streaming data server, a business intelligence (BI) server, and/or other server.

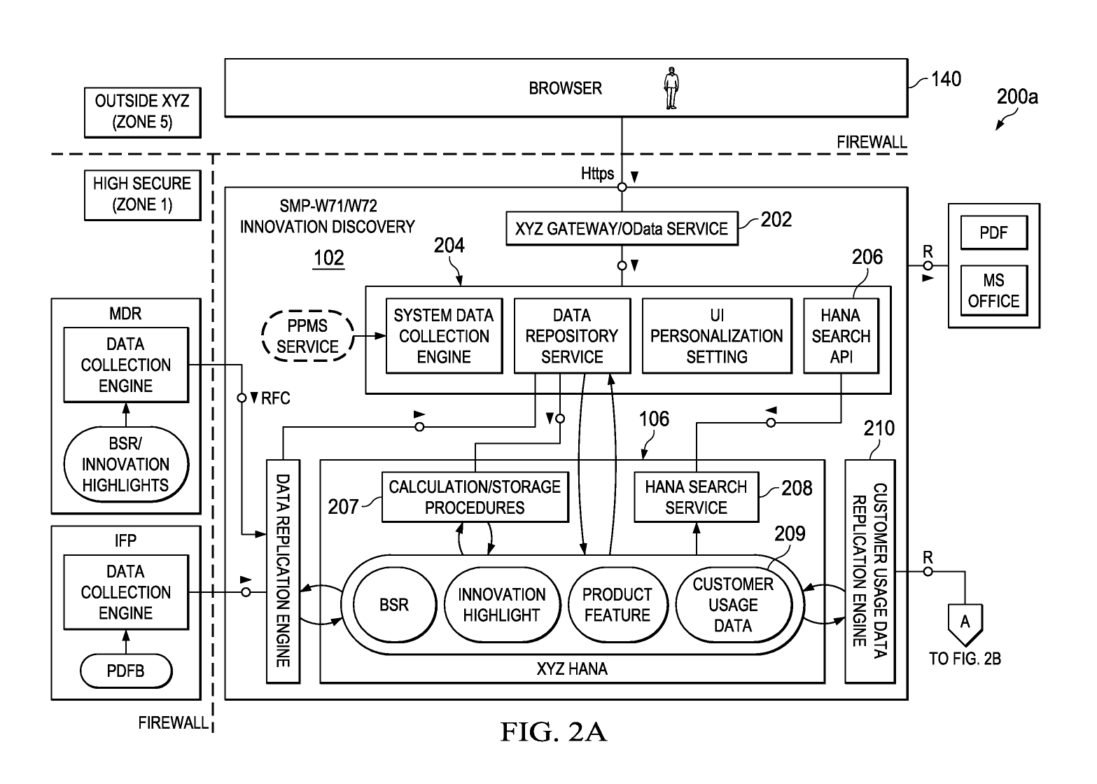

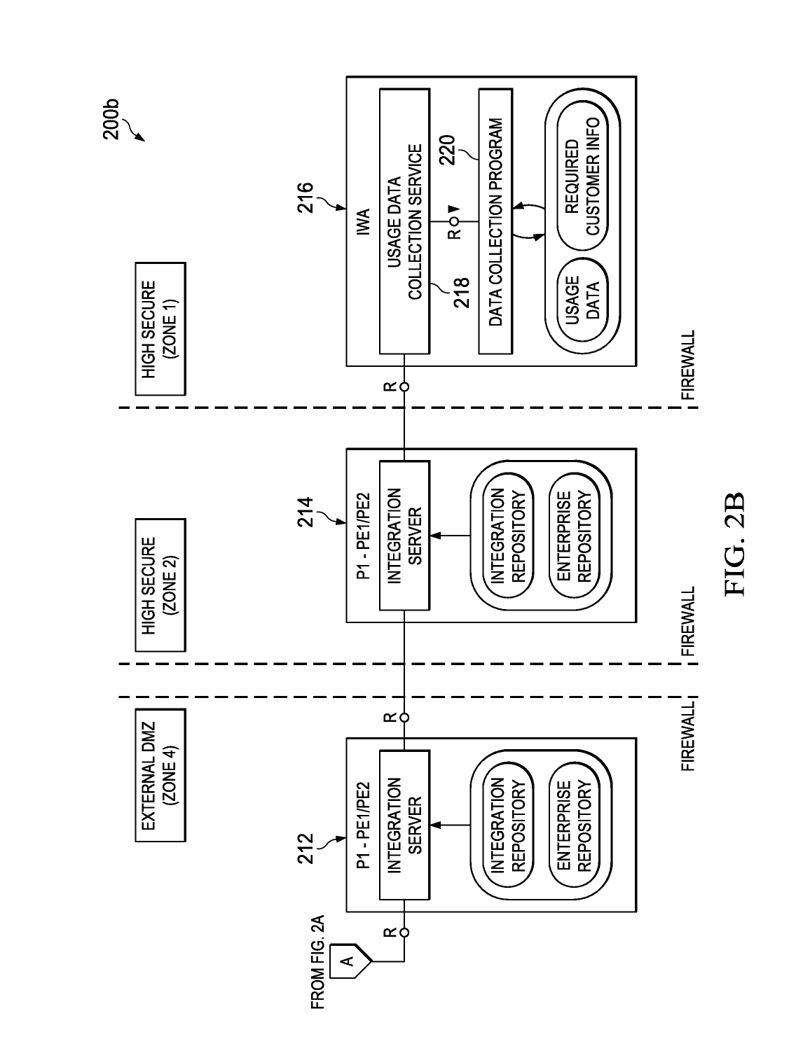

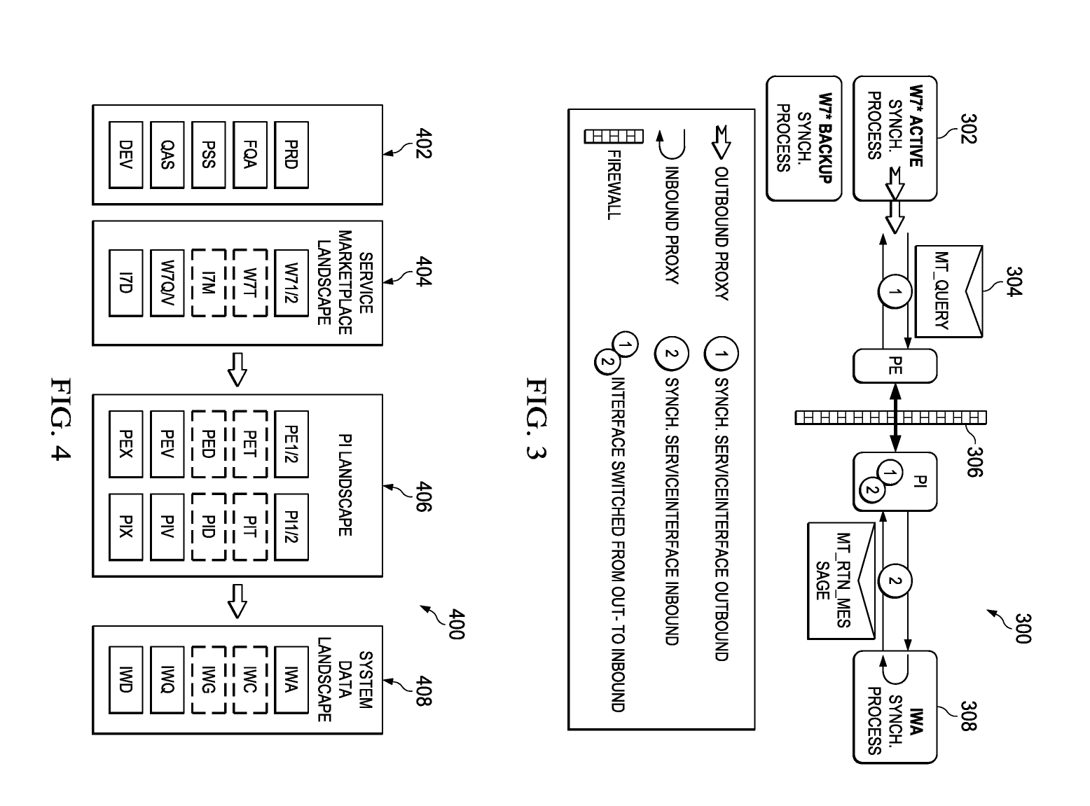

The server 102 is responsible for receiving and responding to, among other things, requests and/or content from one or more client applications 146 associated with the client 140 and other components of the EDCS 100 (see FIGS. 2A-2B) and/or responding to the received requests and/or content. In some implementations, the server 102 processes the requests at least in the innovation discovery engine 107. In addition to requests received from the client 140, requests may also be sent to the server 102 from internal users, external or third-parties, other automated applications, as well as any other appropriate entities, individuals, systems, or computers. In some implementations, various requests can be sent directly to server 102 from a user accessing server 102 directly (e.g., from a server command console or by other appropriate access method).

Each of the components of the server 102 can communicate using a system bus 103. In some implementations, any and/or all the components of the server 102, both hardware and/or software, may interface with each other and/or the interface 104 over the system bus 103 using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the EDCS 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the server 102 in the EDCS 100, alternative implementations may illustrate the API 112 and/or the service layer 113 as stand-alone components in relation to other components of the EDCS 100. Moreover, any or all parts of the API 112 and/or the service layer 113 may be implemented as child or sub-modules of another software module, enterprise application, or hardware module without departing from the scope of this disclosure. For example, the API 112 could be integrated into the innovation discovery engine 107, and/or wholly or partially in other components of server 102 (whether or not illustrated).

The server 102 includes an interface 104. Although illustrated as a single interface 104 in FIG. 1, two or more interfaces 104 may be used according to particular needs, desires, or particular implementations of the EDCS 100. The interface 104 is used by the server 102 for communicating with other systems in a distributed environment—including within the EDCS 100—connected to the network 130; for example, the client 140 as well as other systems communicably coupled to the network 130 (whether illustrated or not). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated EDCS 100.

The server 102 includes a processor 105. Although illustrated as a single processor 105 in FIG. 1, two or more processors may be used according to particular needs, desires, or particular implementations of the EDCS 100. Generally, the processor 105 executes instructions and manipulates data to perform the operations of the server 102. Specifically, the processor 105 executes the functionality required for innovation discovery.

The server 102 also includes a database 106 that holds data for the server 102, client 140, and/or other components of the EDCS 100. Although illustrated as a single database 106 in FIG. 1, two or more databases may be used according to particular needs, desires, or particular implementations of the EDCS 100. While database 106 is illustrated as an integral component of the server 102, in alternative implementations, database 106 can be external to the server 102 and/or the EDCS 100. In some implementations, database 106 can be configured to store one or more instances of and/or some or all data for a PFDB, BFDB, and/or a BSR, as well as RKT material and/or other appropriate data (e.g., user profiles, objects and content, client data, etc.).

The innovation discovery engine 107 is an algorithmic software engine capable of providing, among other things, any function consistent with this disclosure for innovation discovery, for example executing an innovation discovery service generating customer-specific data as to available innovations and GUI interfaces and/or content to display to the customer. In some implementations, the innovation discovery engine 107 can provide and/or modify content provided by and/or made available to other components of the EDCS 100. In other words, the innovation discovery engine 107 can act in conjunction with one or more other components of the server 102 and/or EDCS 100 in responding to a request received from the client 140 and/or other component of the EDCS 100.

Although illustrated as a single innovation discovery engine 107, the innovation discovery engine 107 may be implemented as multiple innovation discovery engines 107. In addition, although illustrated as integral to the server 102, in alternative implementations, the innovation discovery engine 107 can be external to the server 102 and/or the EDCS 100 (e.g., wholly or partially executing on the client 140, other server 102 (not illustrated), etc.). Once a particular innovation discovery engine 107 is launched, the particular innovation discovery engine 107 can be used, for example by an application or other component of the EDCS 100 to interactively process received requests. In some implementations, the innovation discovery engine 107 may be a network-based, web-based, and/or other suitable application consistent with this disclosure.

In some implementations, a particular innovation discovery engine 107 may operate in response to and in connection with at least one request received from other innovation discovery engines 107, other components (e.g., software and/or hardware modules) associated with another server 102, and/or other components of the EDCS 100. In some implementations, the innovation discovery engine 107 can be accessed and executed in a cloud-based computing environment using the network 130. In some implementations, a portion of a particular innovation discovery engine 107 may be a web service associated with the innovation discovery engine 107 that is remotely called, while another portion of the database engine 107 may be an interface object or agent bundled for processing by any suitable component of the EDCS 100. Moreover, any or all of a particular innovation discovery engine 107 may be a child or sub-module of another software module or application (not illustrated) without departing from the scope of this disclosure. Still further, portions of the particular innovation discovery engine 107 may be executed or accessed by a user working directly at the server 102, as well as remotely at a corresponding client 140. In some implementations, the server 102 or any suitable component of server 102 or the EDCS 100 can execute the innovation discovery engine 107.

The client 140 may be any computing device operable to connect to and/or communicate with at least the server 102. In general, the client 140 comprises an electronic computing device operable to receive, transmit, process, and store any appropriate data associated with the EDCS 100, for example, the innovation discovery engine 107. More particularly, among other things, the client 140 can collect content from the client 140 and upload the collected content to the server 102 for integration/processing into/by the innovation discovery engine 107. The client typically includes a processor 144, a client application 146, a memory 148, and/or an interface 149 interfacing over a system bus 141.

The client application 146 is any type of application that allows the client 140 to navigate to/from, request, view, create, edit, delete, administer, and/or manipulate content associated with the server 102 and/or the client 140. For example, the client application 146 can present GUI displays and associated data to a user generated by the innovation discovery engine 107, accept user input, and transmit the user input back to the server 102 for dissemination to the appropriate components of server 102, in particular the innovation discovery engine 107. In some implementations, the client application 146 can use parameters, metadata, and other information received at launch to access a particular set of data from the server 102 and/or other components of the EDCS 100. Once a particular client application 146 is launched, a user may interactively process a task, event, or other information associated with the server 102 and/or other components of the EDCS 100. For example, the client application 146 can generate and transmit a particular request to the server 102.

In some implementations, the client application 146 can also be used perform administrative functions related to the innovation discovery engine 107. For example, the innovation discovery engine 107 can generate and/or transmit administrative pages to the client application 146 based on a particular user login, request, etc.

Further, although illustrated as a single client application 146, the client application 146 may be implemented as multiple client applications in the client 140. For example, there may be a native client application and a web-based (e.g., HTML) client application depending upon the particular needs of the client 140 and/or the EDCS 100.

The interface 149 is used by the client 140 for communicating with other computing systems in a distributed computing system environment, including within the EDCS 100, using network 130. For example, the client 140 uses the interface to communicate with a server 102 as well as other systems (not illustrated) that can be communicably coupled to the network 130. The interface 149 may be consistent with the above-described interface 104 of the server 102. The processor 144 may be consistent with the above-described processor 105 of the server 102. Specifically, the processor 144 executes instructions and manipulates data to perform the operations of the client 140, including the functionality required to send requests to the server 102 and to receive and process responses from the server 102.

The memory 148 typically stores objects and/or data associated with the purposes of the client 140 but may also be consistent with the above-described database 106 of the server 102 or other memories within the EDCS 100 and be used to store data similar to that stored in the other memories of the EDCS 100 for purposes such as backup, caching, and the like.

Further, the illustrated client 140 includes a GUI 142 that interfaces with at least a portion of the EDCS 100 for any suitable purpose. For example, the GUI 142 (illustrated as associated with client 140a) may be used to view data associated with the client 140, the server 102, or any other component of the EDCS 100. In particular, in some implementations, the client application 146 may render GUI interfaces and/or content for GUI interfaces received from the innovation discovery engine 107 and/or display data retrieved from database 106 using the innovation discovery engine 107.

There may be any number of clients 140 associated with, or external to, the EDCS 100. For example, while the illustrated EDCS 100 includes one client 140 communicably coupled to the server 102 using network 130, alternative implementations of the EDCS 100 may include any number of clients 140 suitable to the purposes of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140d) is intended to encompass any computing device such as a desktop computer/server, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142 (illustrated by way of example only with respect to the client 140a).

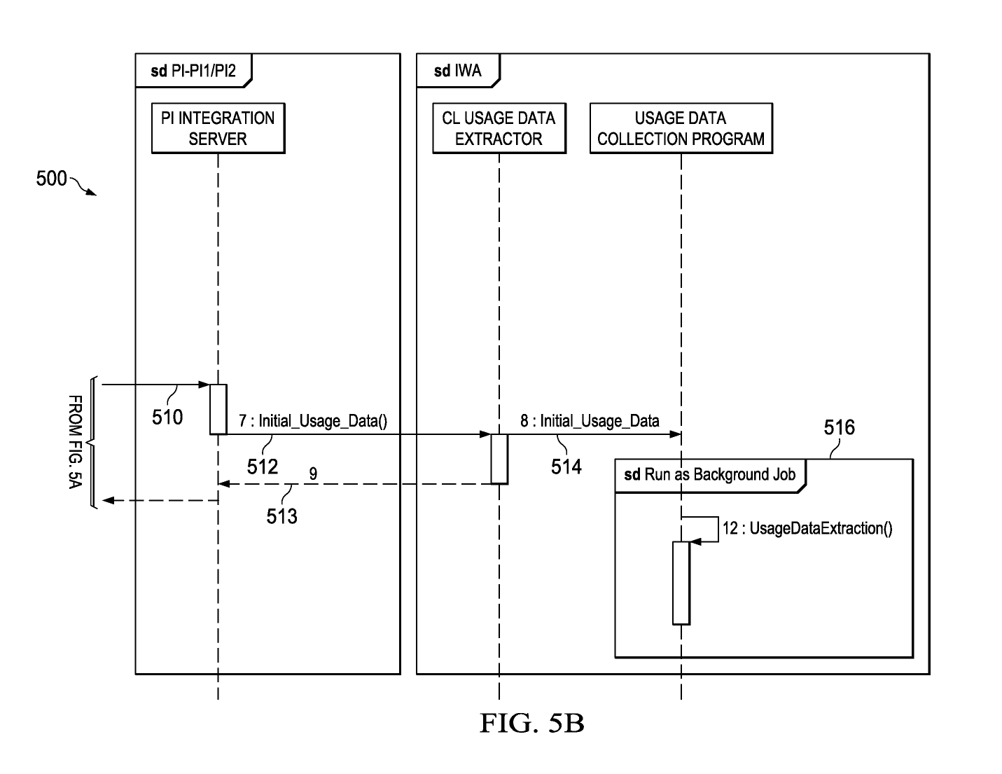

FIG. 2A is a block diagram 200a illustrating a portion of a lower-level EDCS 100 for innovation discovery according to an implementation. For each S-user outside a secure system 102 (e.g., using client 140) logged in to the EDCS 100, the innovation discovery service will check the usage data availability status to determine whether to initialize a customer usage data extraction request (see FIG. 5) using a process integration proxy (PI-Proxy).

The S-user request is received, processed, and relayed thought a gateway service 202 to a product and production service 204. The request for usage data is handled by system selection for the first time access using customer usage data replication engine 210. Afterwards, customer usage data will be pushed to local database 202 periodically by batch program 220 in a business warehouse system (IWA).

The search API 206 requests generic data (BSR, innovation, product features and other standard information) from the local database via search service 208 in the service marketplace.

FIG. 2B is a block diagram 200b illustrating the remaining portion of a lower-level EDCS 100 for innovation discovery according to an implementation. The customer usage data replication engine 210 makes a request to a process integration server PE1/PE2 (primary and backup) 212 outside of the secure system (e.g., in a network DMZ). From 212, the request is transferred to a process integration server PI1/PI2 214 in highly secure network zone as illustrated on FIG. 2B. From 214, the request is passed to the IWA 216.

At the IWA 216, customer usage data is retrieved using the usage data collection service 218 and passed back to the requestor (using PI1/PI2 214, etc.). A data collection program 220 is also started for the customer (using customer information 222 stored in the IWA 216 for future use) to periodically gather and send usage data back to the service marketplace 102. Here, an incoming usage data extraction request from a customer is received and the customer access information is saved into a local application database 202 via customer usage data replication engine 210. The periodic batch job will read the customer access database and push customer-based usage data to the service marketplace 102, in other words, retrieve and push customer-based usage data.

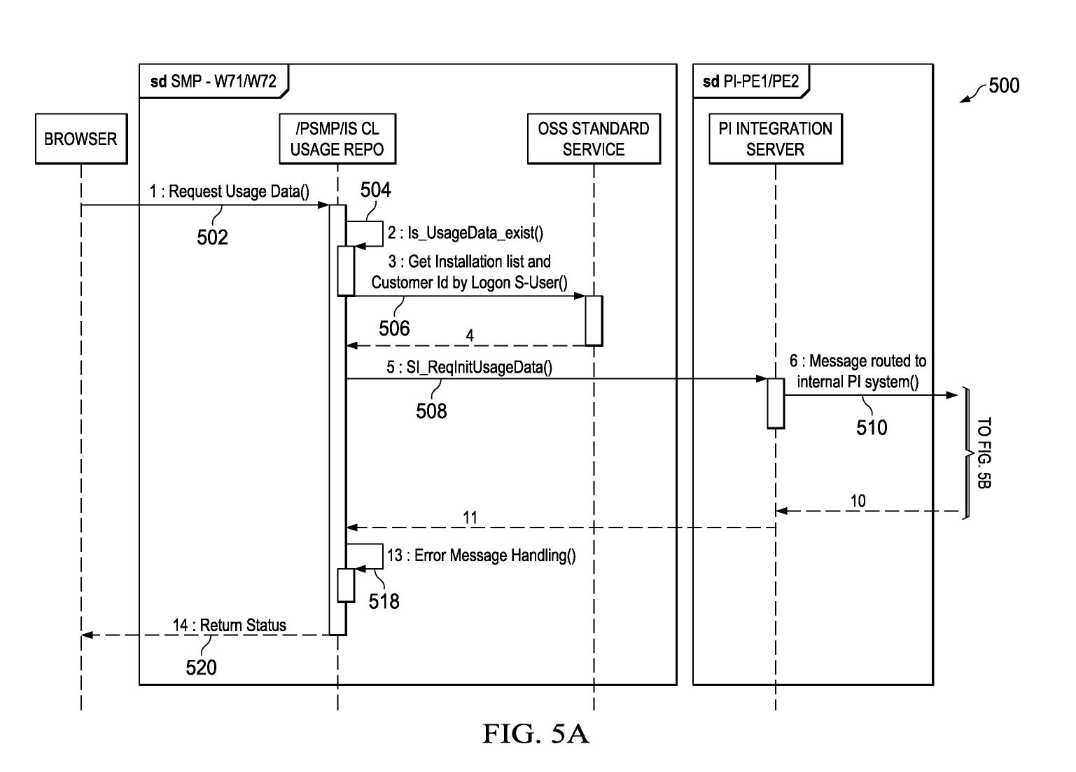

Note that additional detail with respect to the description of FIGS. 2A and 2B may be found with FIGS. 3-8 and associated description below.

FIG. 3 is a block diagram 300 illustrating an integration scenario overview of a usage data initiative according to an implementation. The service marketplace 302 (labeled “W7* active” and “W7* Backup”) is illustrated on the left and generates a query 304 (e.g., “MT_QUERY”) for customer usage data (e.g., a customer accessing the service marketplace 302 using a browser makes a request for usage data). In typical implementations, the customer is an S-user. For each customer logon, the service marketplace/innovation discovery service will check the usage data availability status to determine whether there is a need to request an initial usage data extraction request using a process integration landscape (acting a proxy) to securely pass the query to a business integration system for storing customer usage data. The query is routed through a process integration (PI) landscape 306 (for additional detail refer to FIGS. 4 and 5) and to IWA 308. The PI landscape 306 provides a secure method for customer usage data to make it into/out of the IWA 308. The IWA 308 processes the query and returns requested customer usage data to the PI landscape 306 and to the service marketplace 302 to be provided to the requestor. Returned PI messages (e.g., with customer usage data) can be persisted in an Innovation Discovery application message.

FIG. 4 is a block diagram 400 illustrating the primary landscapes of the innovation discovery service for the usage data initiative according to an implementation. 404 describes the service marketplace (SMP) landscape, 406 describes the process integration (PI) landscape used exchange processes, data, etc. from one system to another system, and 408 describes the Business Warehouse (BW) system landscape used to store customer data or any data in a particular format and provide tools for analysis. 402 describes five system types associated with each described landscape. For example, “PRD” stands for “production system,” “FQA” for “final quality assurance system,” “PSS” for “production maintenance system,” “QAS” for “quality assurance system,” and “DEV” for “development system.” In reading FIG. 4, the W71/2 systems (load balanced between for a user to access) as part of the service marketplace landscape 404 would be part of the PRD while I7D would be a development version of the service marketplace that is part of the DEV system. Likewise, IWC under the system data landscape 408 would be part of FQA. With the prior descriptions, it should be clear that there is a production, final quality assurance, production maintenance system, quality assurance, and development version of each of the SMP, PI, and system data landscapes.

FIG. 5 is a flow chart 500 illustrating integration of customer usage data into a service marketplace according to an implementation. For clarity of presentation, the description that follows generally describes flow 500 in the context of FIGS. 1, 2A-2B, and 3-4. However, it will be understood that flow 500 may be performed, for example, by any other suitable system, environment, software, and hardware, or a combination of systems, environments, software, and hardware as appropriate. In some implementations, various steps of flow 500 can be run in parallel, in combination, in loops, and/or in any order.

At 502, an S-user initiates a request to recover usage data from the service marketplace landscape 404 (e.g., using a browser). FIG. 5, 502 illustrates the request to particular production (PRD) systems W71/W72. The request is received by an interface (e.g., represented by /PSMP/IS_CL_USAGE_REPO and situated in the W71/W72 systems. From 502, flow 500 proceeds to 504.

At 504, the interface of 502 determines whether locally (on service marketplace) usage data already exists. If usage data exists for a particular customer, a request to retrieve remote usage data is not needed. In some implementations, the availability of usage data can be checked for a particular time period (e.g., within the last six months or within the last year). Note that not all customers may have sent usage data to the system so the check is to determine where there is usage data to work with. If no usage data exists, the customer can use generic data (innovations, product features, RKT and so on). From 504, flow 500 proceeds to 506.

At 506, a customer authorized system list is retrieved using the s-user's login credentials. The customer system list is returned to the interface of 502. From 506, flow 500 proceeds to 508.

At 508, the interface of 502 initiates a request for initial usage data to IWA (e.g., a data business warehouse type system of customer usage-related data) in the system data landscape 408. The request is initial because if no local usage data was detected at 504, usage data has not yet been collected for the customer (once usage data is collected for a first time, a record is made of this fact and an automated collection job pushes customer usage data to the service marketplace—see FIGS. 3-8 for additional detail). Note that the IWA is external to the service marketplace landscape and must be accessed using one or more interfaces. The request is sent through the PE1/PE2 and PI1/PI2 process integration server interfaces in the PRD PI system landscape 406. In some implementations, the PE1/PE2 and PI1/PI2 process integration server interfaces are only used to transport requests to IWA. Note that PE1/PE2 are two “external” (hence the “PE” moniker) systems providing an external interface to/from “external” systems (e.g., the service marketplace landscape 404), while the PI1/PI2 are two “internal” (hence the “PI” moniker) systems providing an internal interface to/from “internal” systems (e.g., the system data landscape 408). From 508, flow 500 proceeds to 510.

At 510, the PE1/PE2 process integration server interface passes the initial usage data request to the PI1/PI2 process integration server interface. From 510, flow 500 proceeds to 512.

At 512, the PI1/PI2 process integration server interface receives the initial usage data request and passes it to a usage data extractor process in the IWA. From 512, flow 500 proceeds to both 513 (returning gathered initial usage data in response to the request for initial usage data and proceeding to 518) and 514.

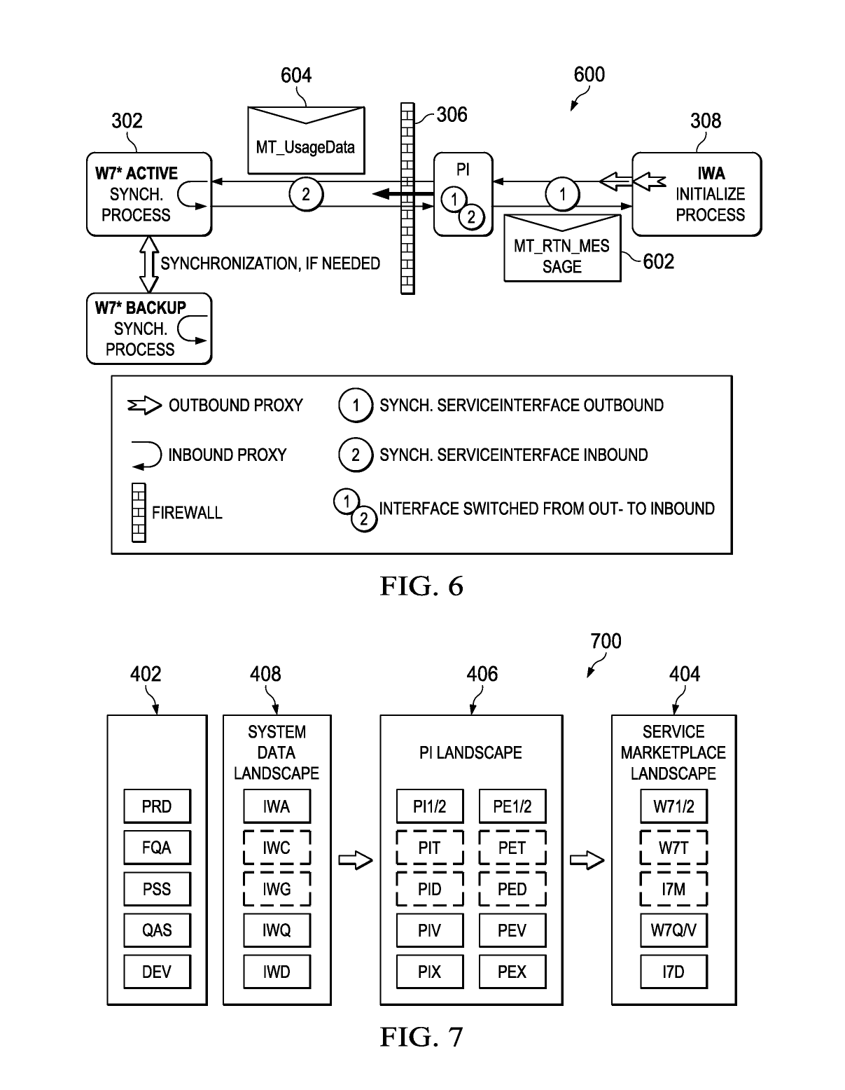

At 514, a periodic background job 516 is started using a separate usage data collection program on the IWA to gather usage data for the accessed customer and to push it to the service marketplace (refer to FIGS. 6-8) because initial usage data was requested at least once from the IWA. This periodic job is designed to make the usage data proactively available. The customer data is also stored to allow for the periodic usage data gathering and push to the service marketplace. In some implementations, the periodic nature of the job can be configured (e.g., hourly, daily, weekly collections). In some implementations, the job can also be triggered manually at any specific point in time. From 516, flow 500 proceeds to 518.

At 518, any error messages received as a result of the above-describe flow (e.g., in 502-516) are handled by the interface of 502. From 518, flow 500 proceeds to 520.

At 520, the status is returned to the customer (e.g., to the browser). From 520, flow 500 stops.

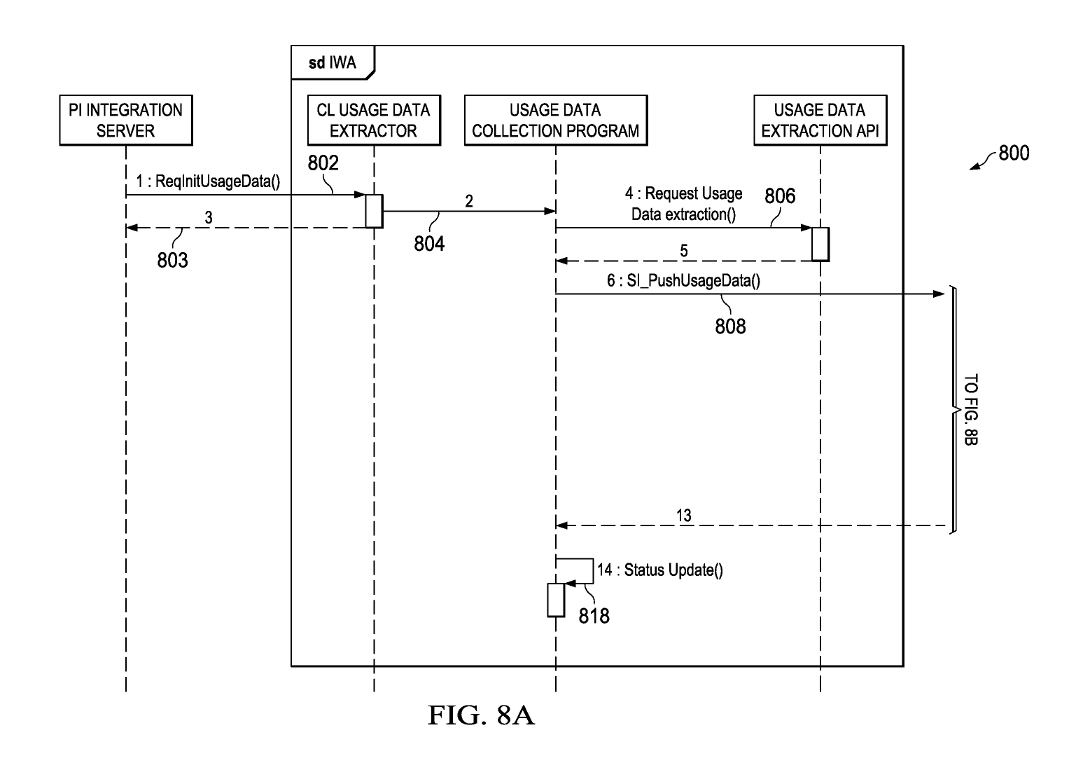

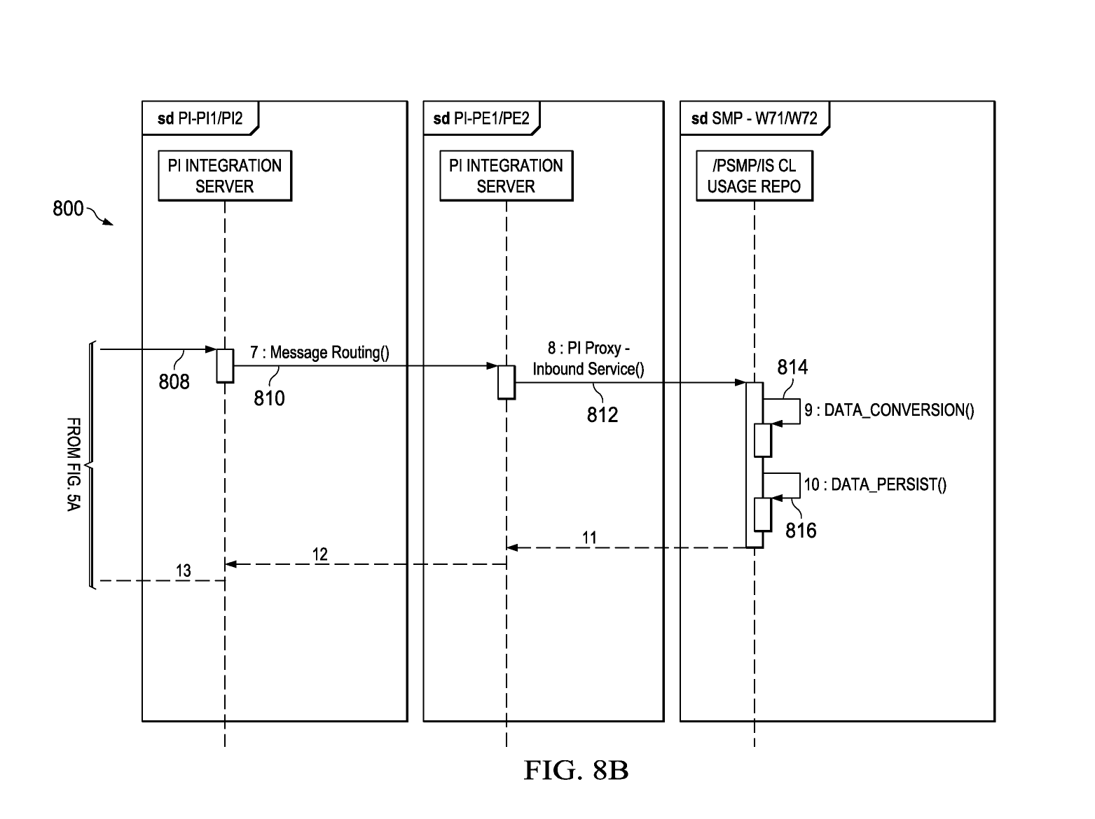

FIG. 6 is a block diagram 600 illustrating an integration scenario overview of pushing usage data from a business warehouse system according to an implementation. The IWA 308 generates and pushes (e.g., periodically—refer to FIG. 5, 514 for additional detail) customer usage data in a message 602 (refer to FIG. 8, 802-808 for additional detail). In some implementations, the customer usage data can include information such as number of users for each functionality, transaction code (e.g., generate/modify/close a purchase order), step count (e.g., usage frequency of a transaction code), modified transaction code (e.g., customers can change transaction code functionality to meet their individual requirements—add new fields or logic, etc.), and/or other data. The usage data message 602 is securely passed through a process integration (PI) landscape 306 (for additional detail refer to FIGS. 3, 5, and 7-8; also refer specifically to FIG. 8, 808-812) to a service marketplace 302 (labeled “W7* active” and “W7* Backup”) in a usage data message 604 (e.g., “MT_UsageData”). At the service marketplace 302, a customer can access applicable customer usage data that is converted and persisted in a database and/or data storage location accessible to the service marketplace 302 (e.g., using a browser). The customer usage data is also synched between the W7* active and the W7* Backup systems.

FIG. 7 is a block diagram 700 illustrating the primary landscapes of the innovation discovery service for pushing usage data from a business integration system according to an implementation. FIG. 7 is consistent with the description related to FIG. 4 other than the system data landscape 408, PI landscape 406, and SMP landscape 404 are reversed to reflect the pushing of usage data from a business integration system (refer to FIGS. 6 and 8 for additional detail).

FIG. 8 is a flow chart 800 illustrating customer usage data being pushed from a business integration system to the service marketplace according to an implementation. For clarity of presentation, the description that follows generally describes flow 800 in the context of FIGS. 1, 2A-2B, and 3-7. However, it will be understood that flow 800 may be performed, for example, by any other suitable system, environment, software, and hardware, or a combination of systems, environments, software, and hardware as appropriate. In some implementations, various steps of flow 800a/b can be run in parallel, in combination, in loops, and/or in any order.

802, 803, 804, and 806 mirror the description provided above with FIGS. 5 and 502-512, 513, 514, and 516, respectively. Newly described functionality is described beginning at 808.

At 808, The IWA usage data collection program pushes usage data (according to the defined periodic and/or one-off schedule at 514 above) to the PI1/PI2 process integration server interface. From 808, flow 800 proceeds to 810.

At 810, the PI1/PI2 process integration server interface routes the usage data to the PE1/PE2 process integration server interface. From 810, flow 800 proceeds to 812.

At 812, the PE1/PE2 process integration server interface transmits the usage data to the service marketplace as in 514 above. From 812, flow 800 proceeds to 814.

At 814, the usage data is converted. For example, usage data can be merged, an index can be built from the usage data to allow for searching, etc. From 814, flow 800 proceeds to 816.

At 816, the converted usage data is persisted into a database and/or other data storage location accessible by the service marketplace systems (e.g., W71/W72). From 816, flow 800 proceeds to 818.

At 818, a status for the push of the usage data to the service market place is updated with the usage data collection program. If, for example, an error is encountered, the IWA can be requested to re-send the usage data to the service marketplace. From 818, flow 800 stops.

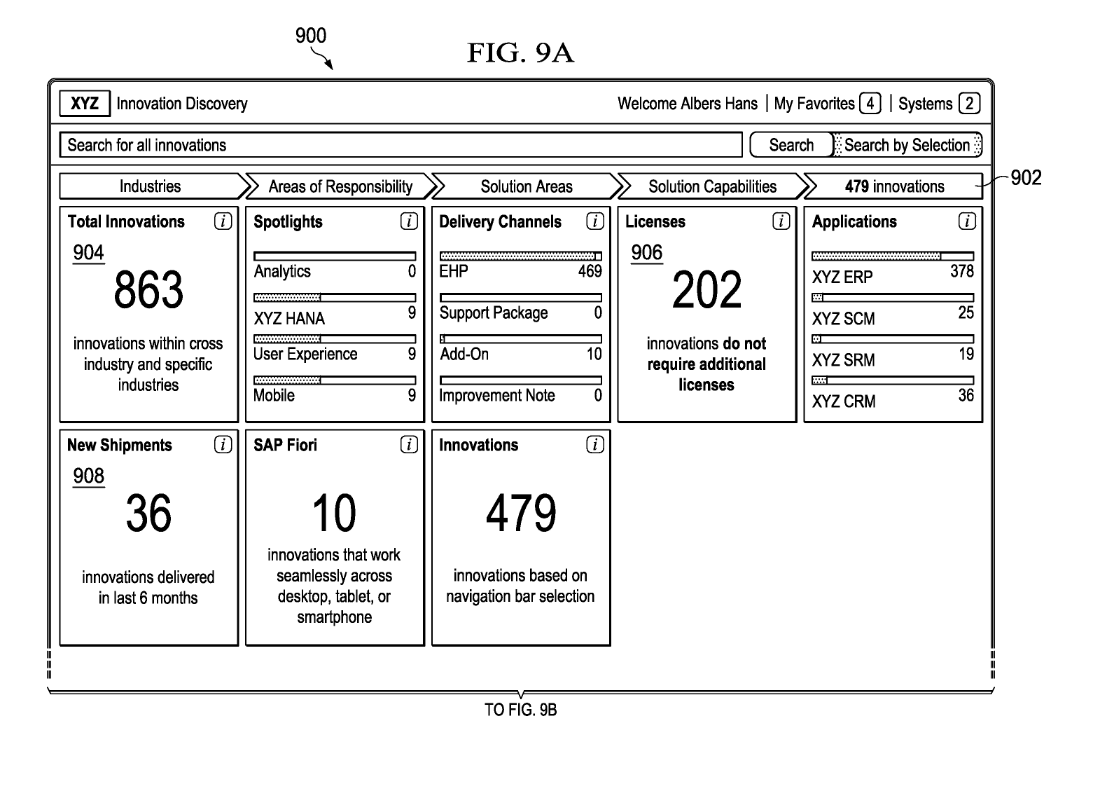

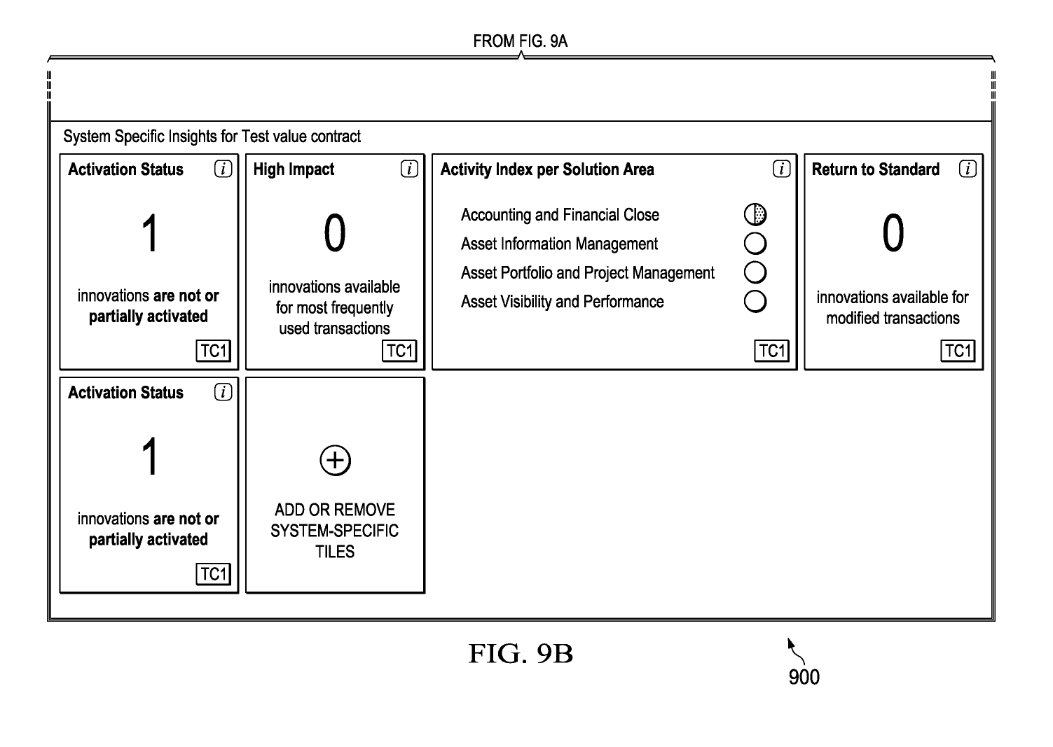

FIG. 9 is an example screenshot 900 of an S-user home page user interface according to an implementation. The home page user interface is designed to present various types of innovation-related data to the user in a comfortable and useful manner. The example screenshot 900 illustrates indicator 902 that the S-user home page user interface 900 is an innovation dashboard page. Various types of data are available to the S-user on home page user interface 900. For example, a total number of innovations 904 available to the S-user, innovations not requiring additional licenses 906, and innovations delivered to the customer in the last 6 months. As will be appreciated by those of ordinary skill in the art, the illustrated home page user interface 900 is only one possible example of innovation data that can be presented to a user. The example home page user interface 900 is not meant to be limiting in any way but enhance the understanding of the subject matter of this disclosure.

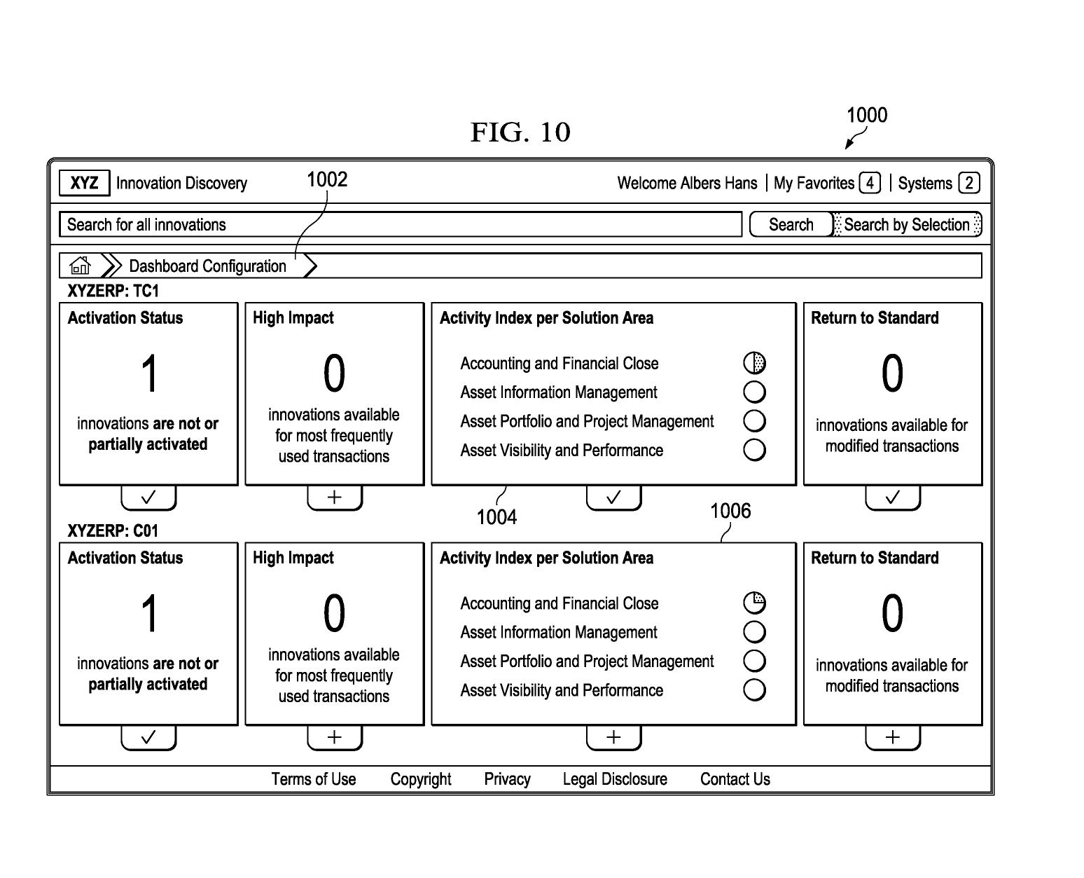

FIG. 10 is an example screenshot 1000 of a dashboard user interface configuration page only for customer specific usage data according to an implementation. The dashboard user interface configuration page 1002 is designed to allow an S-user to configure the S-user home page user interface (or other associated user interface) of FIG. 9. As illustrated, the screen 1002 provides various GUI elements for addition or removal from the screen 1002. For example, Activity Index per Solution Area 1004 is marked with a check mark (below the element) and will be displayed on the S-user home page user interface (or other associated user interface) of FIG. 9 for ERP system TC1, whereas the Activity Index per Solution Area 1006 is not checked (below the element) and will not be displayed on the S-user home page user interface (or other associated user interface) of FIG. 9 for ERP system C01. As will be appreciated by those of ordinary skill in the art, the illustrated dashboard user interface configuration page 1002 is only one possible example of a configuration page that can be presented to a user. The example dashboard user interface configuration page 1002 is not meant to be limiting in any way but enhance the understanding of the subject matter of this disclosure.

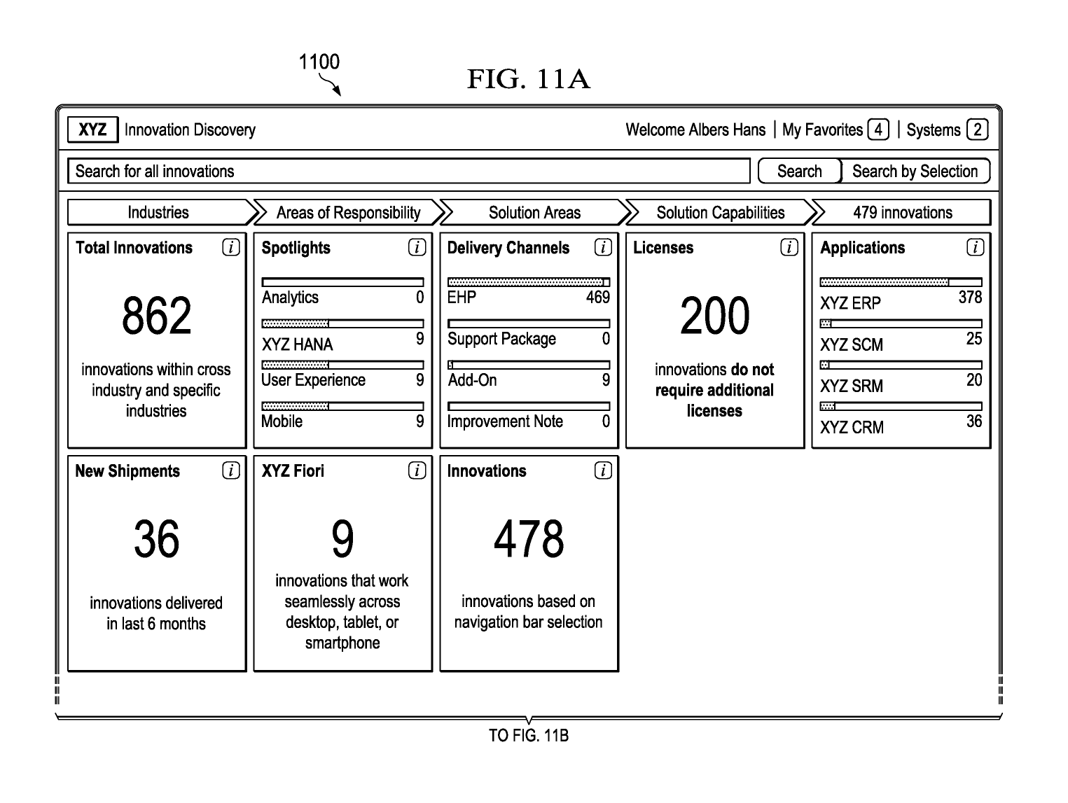

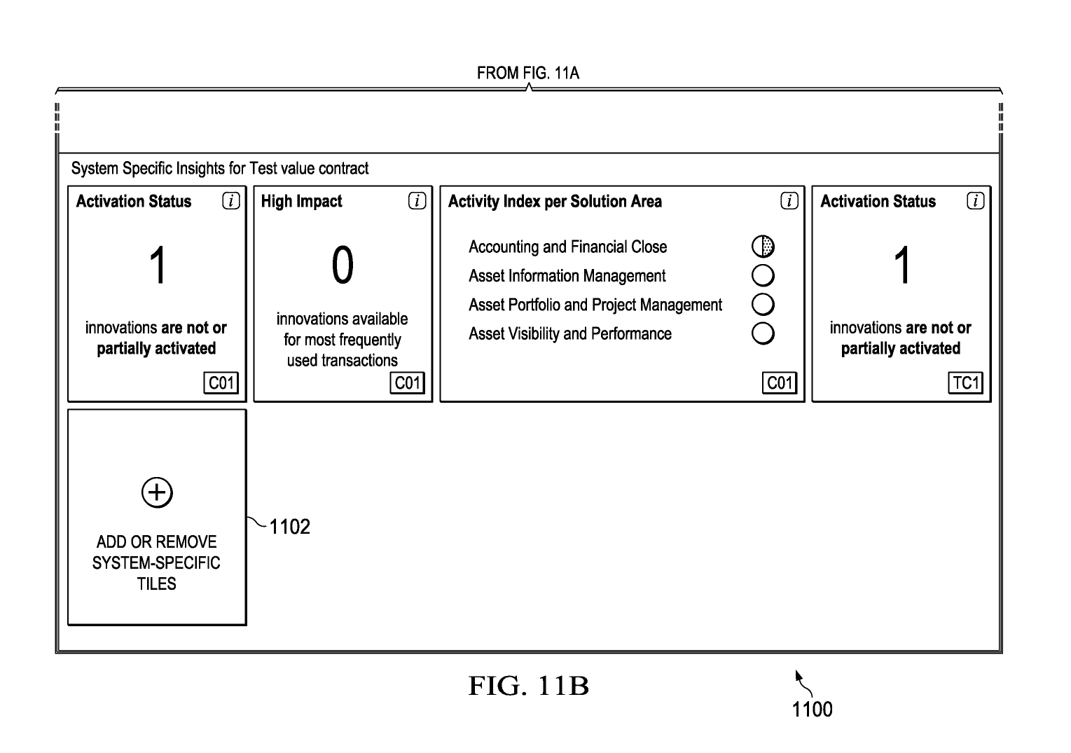

FIG. 11 is an example screenshot 1100 of an alternative example dashboard user interface and dashboard configuration according to an implementation. The example screenshot 1100 illustrates the functional ability (using tile 1102) to add or remove system-specific tiles from a home page user interface (e.g., 900). In some implementations, selecting tile 1102 can present a dashboard user interface configuration page similar to 1002 or of some other configuration consistent with this disclosure to add or remove system specific tiles.

In some implementations, three JAVASCRIPT files, e.g., dashboard_common.js, dashboard.js, and dashboardconfig.js are responsible for assembling data and creating tiles with provided GUI data. In this implementation, dashboard.js can create and refresh tile areas on a home page. Dashboardconfig.js can create and refresh a dashboard configuration page (e.g., FIG. 10 or some other dashboard configuration page). As described above, the dashboard configuration page is displayed once user clicks tile 1102 on the page. Dashboard_common.js can define variables and helper functions common to both of the other JAVASCRIPT files.

The following are major objects or functions in the three described JAVASCRIPT files:
a. innovserv.dashboard_common.usageKpi in dashboard_common.js
   An array containing metadata for tiles displaying usage data related KPI.
b. nonUsageKpi in dashboard.js
   An array containing metadata for tiles displaying KPI not related to usage data.
c. refreshTilePage and refreshALLTiles in dashboard.js
   Two functions that empty the tiles area on home page, and then recreate all tiles with data fetched from backend.
d. addOneTile and delteOneTile in dashboard.js
   Two functions that add/delete one tile to/from tiles area on home page.
e. refreshTiles and refreshTilesPage in dashboardonfig.js
   Two functions are similar to that of ‘c’ above. They empty the dashboard configuration page, and recreate all tiles with data fetched from the backend.
f. prepUsageData in dashboardconfig.js
   Transforms data fetched from the backend to a proper structure that can be used to create tile controls.
      In some implementations, all the tiles on the S-user home page user interface and dashboard user interface configuration page are based on a similar set of user defined controls. As will be appreciated by those of ordinary skill in the art, the described example implementation is only one possible example of an implementation consistent with the describe subject matter and is not meant to be limiting in any way but enhance the understanding of the subject matter of this disclosure.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a request from a customer for usage data, the request received at a request interface for a service marketplace;
upon a determination that usage data exists for the customer, initiating a request for usage data;
routing the request for usage data though an external and internal process integration server system interface to a business information system;
extracting usage data for the customer from the business information system; and
return usage data to the requesting customer.

2. The method of claim 1, wherein the customer has S-user authority.

3. The method of claim 1, wherein the determination that usage data exists for the customer can be performed for usage data within a specific time period.

4. The method of claim 1, further comprising upon a determination that usage data does not exist for the customer, informing the customer of the availability of non-usage data.

5. The method of claim 1, further comprising determining whether the routed request is a first request for usage data for the customer.

6. The method of claim 5, further comprising initiating a periodic background job on the business information system to gather usage data for the customer.

7. The method of claim 6, wherein the gathered usage data for the customer is periodically pushed to the service market place.

8. The method of claim 7, further comprising:
converting the usage data pushed to the service market place; and
persisting the converted usage data.

9. The method of claim 8, further comprising returning a status update of the usage data push to the business information system.

10. A non-transitory, computer-readable medium storing computer-readable instructions executable by a computer and configured to:
receive a request from a customer for usage data, the request received at a request interface for a service marketplace;
upon a determination that usage data exists for the customer, initiate a request for usage data;
route the request for usage data though an external and internal process integration server system interface to a business information system;
extract usage data for the customer from the business information system; and
return usage data to the requesting customer.

11. The medium of claim 10, wherein the customer has S-user authority.

12. The medium of claim 10, wherein the determination that usage data exists for the customer can be performed for usage data within a specific time period.

13. The medium of claim 10, further comprising upon a determination that usage data does not exist for the customer, instructions to inform the customer of the availability of non-usage data.

14. The medium of claim 10, further comprising instructions to determine whether the routed request is a first request for usage data for the customer.

15. The medium of claim 14, further comprising instructions to initiate a periodic background job on the business information system to gather usage data for the customer.

16. The medium of claim 15, wherein the gathered usage data for the customer is periodically pushed to the service market place.

17. The medium of claim 16, further comprising instructions to:
convert the usage data pushed to the service market place; and
persist the converted usage data.

18. The medium of claim 17, further comprising returning a status update of the usage data push to the business information system.

19. A system, comprising:
a memory;
at least one hardware processor interoperably coupled with the memory and configured to:
receive a request from a customer for usage data, the request received at a request interface for a service marketplace;
upon a determination that usage data exists for the customer, initiate a request for usage data;
route the request for usage data though an external and internal process integration server system interface to a business information system;
extract usage data for the customer from the business information system; and
return usage data to the requesting customer.

20. The system of claim 19, further comprising instructions to initiate a periodic background job on the business information system to gather usage data for the customer, wherein the gathered usage data for the customer is periodically pushed to the service market place and the usage data is converted and persisted at the service market place.
